(19) United States
(12) Patent Application Publication
(10) Pub. No.: US 2013/0275492 A1
(43) Pub. Date: Oct. 17, 2013

(54) Enabling Web Clients to Provide Web Services

(71) Applicants: Matthew T. Kaufman, Bonny Doon, CA (US); Jacek A. Korycki, San Jose, CA (US); Raviprakash Ramanujam, Mountain View, CA (US)

(72) Inventors: Matthew T. Kaufman, Bonny Doon, CA (US); Jacek A. Korycki, San Jose, CA (US); Raviprakash Ramanujam, Mountain View, CA (US)

(73) Assignee: Microsoft Corporation, Redmond, WA (US)

(21) Appl. No.: 13/447,065

(22) Filed: Apr. 13, 2012

(51) Int. Cl. G06F 15/16

(52) U.S. Cl. 709/203

(57) ABSTRACT

Various embodiments enable web clients to provide web services. In one or more embodiments, web clients are configured to act as servers and can be used for, among other purposes, to and from calling of web services supported by the web client. Such uses can include, by way of example and not limitation, pushing messages to and from the web client. The various techniques can utilize standard protocols and libraries and without the need for any custom code or custom plug-ins.

### BACKGROUND

When web servers conduct transactions with each other, a very common programming pattern is to use HTTP as the transport. For example, a first server may issue an HTTP GET request to request a representation of a particular resource from a second server. The second server can, in turn, respond with the resource representation. Transactions between servers can also take place in a more asynchronous manner. For example, the first server may issue an HTTP GET request and provide a return URL for the second server to use in responding. At some later time, the second server can asynchronously return to the first server using the URL provided by the first server. This process can also easily operate in reverse between the servers.

Using this same model, transactions between client side applications, such as web browsers, and servers can operate with the client side application issuing an HTTP GET request and receiving a response from the server. However, the same cannot be said of the reverse process. Specifically, servers cannot typically issue HTTP GET or POST requests to client side applications or web browsers because, among other reasons, web browsers do not typically run a web server. Even if they did, firewalls or other mechanisms such as Network Address Translation (NAT) devices would render it practically impossible for such transactions to take place.

### SUMMARY

This Summary is provided to introduce a selection of concepts in a simplified form that are further described below in the Detailed Description. This Summary is not intended to identify key features or essential features of the claimed subject matter.

Various embodiments enable web clients to provide web services. In one or more embodiments, web clients are configured to act as servers and can be used for, among other purposes, to and from calling of web services supported by the web client. Such uses can include, by way of example and not limitation, pushing messages to and from the web client. The various techniques can utilize standard protocols and libraries and without the need for any custom code or custom plug-ins.

In one or more embodiments, an intermediate server functions as an intermediary with which a persistent connection with a web client is established. The intermediary server, in turn, can publish the web client to the world using, for example, the web client's presence or address, such as a web service URL. Other web clients (e.g., a browser based client) seeking to send a message to the first web client can use the published web-service URL to call a predefined web-service. The calling web client can also register with either the same intermediary server or a different intermediary server and publish its web-service URL. The first web client can then use this URL to push messages to the second web client.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation in accordance with one or more embodiments.

FIG. 2 is an illustration of another environment in an example implementation in accordance with one or more embodiments.

FIG. 3 is an illustration of a communication flow between two web clients in accordance with one or more embodiments.

FIG. 4 is an illustration of an example sequence flow between a caller, a tunnel service, and a web client in accordance with one or more embodiments.

FIG. 5 is a flow diagram depicting a procedure in an example implementation in accordance with one or more embodiments.

FIG. 6 illustrates an example system including various components of an example device that can be implemented as any type of computing device as described with reference to FIGS. 1 and 2 to implement embodiments of the techniques described herein.

### DETAILED DESCRIPTION

Overview

Various embodiments enable web clients to provide web services. A web service is a program that can be invoked by sending to it an HTTP request, addressed to a specific URL, and carrying the input parameters within various fields of the HTTP request, including the URL, the headers and the body. In turn, the output parameters that are the result of the program computation, are returned within various fields of the HTTP response, including the status code, the headers and the body. In one or more embodiments, web clients are configured to act as servers and can be used for, among other purposes, to and from calling of web services supported by the web client. Such uses can include, by way of example and not limitation, pushing messages to and from the web client. The various techniques can utilize standard protocols and libraries and without the need for any custom code or custom plug-ins. The various techniques can be used, for example, to implement browser based chat clients using standard protocols and libraries and without requiring any custom code or plug-in installation in browsers. In at least some embodiments, standard HTTP techniques can be utilized without the necessity to modify the structure of the HTTP communication that takes place.

In one or more embodiments, an intermediate server functions as an intermediary with which a persistent connection with a web client is established. The persistent connection can be established using any suitable technologies or techniques. By way of example and not limitation, such technologies or techniques can include COMET, WebSockets, and the like. The intermediary server, in turn, can publish the web client to the world using, for example, the web client's presence or address, such as a web service URL. Other web clients (e.g., a browser based client) seeking to send a message to the first web client can use the published web-service URL to call a predefined web-service. The calling web client can also register with either the same intermediary server or a different intermediary server and publish its web-service URL. The first web client can then use this URL to push messages to the second web client.

The techniques described herein can be employed for a multitude of practical uses. For example, the various embodiments can enable implementation of browser based clients using standard web-services technologies. Since the browsers are capable of calling web services without any plug-in installation, the browser client can be designed to be very light weight and can work on any device that has a web-browser. Hence, a variety of flexible use scenarios can be provided. In addition, the techniques described in this document can be widely applicable to scenarios that are not browser based. For example, the techniques can be utilized by any suitably configured device including, by way of example and not limitation, embedded devices. For example, such embedded devices can take the form of those that can be employed in a variety of scenarios such as “smart home” or “smart office” scenarios where, for example, a device such as a light switch can be configured as an embedded device to offer and consume web services as described in this document.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

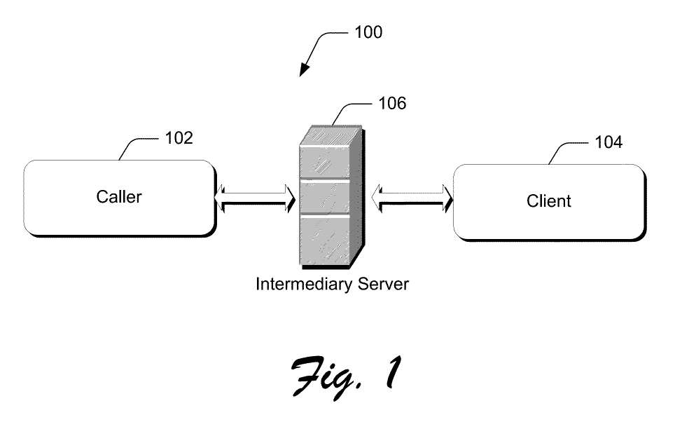

FIG. 1 is an illustration of an example environment 100 in accordance with one or more embodiments. Environment 100 includes a caller 102, a client 104, and an intermediary server 106.

Caller 102 can comprise any suitably-configured caller such as, by way of example and not limitation, a client computing device, a server, or any other entity that is configured to call intermediary server 106. In one or more embodiments, the caller and client can comprise any suitable software agents running on any suitable computing device, examples of which are provided below. The agents are configured to use the methods described in this document to communicate, e.g., HTTP methods, as well as a variety of persistent connection types for the client. In the illustrated and described embodiment, client 104 includes a persistent connection with intermediary server 106. Any suitable technology can be utilized to enable the persistent connection to be established. The intermediary server 106 implements a tunnel service that is identified by a tunnel endpoint. As noted above, client 104 can comprise any suitable type of client. In the various examples used in this document, the client 104 comprises a web client that can, but need not necessarily reside as a web browser or an agent that leverages browser-based techniques to communicate. Client 104 need not, however, leverage browser-based techniques to communicate. For example, client 104 may reside in the form of a mobile client or embedded device that utilizes a native library for tunneling with intermediary server 106, as will be appreciated by the skilled artisan. Web client 104 registers with intermediary server 106 using a tunnel ID.

In operation, caller 102 utilizes standard web protocols, such as HTTP or HTTPS, to call the intermediary server 106 using standard verbs. This can be done without any modifications to the standard HTTP techniques that are utilized to communicate. The call issued by caller 102 includes the tunnel endpoint associated with intermediary server 106, the tunnel ID associated with Web client 104 and a payload which identifies a web service implemented by web client 104 and data or information that is to be processed by the web service implemented by the web client. The intermediary server 106 then processes the call by converting it into a standard web structure that can be processed by the web client. For example, the intermediary server 106 can serialize the call and encapsulate it in a standard web structure. The encapsulated structure is then communicated by the intermediary server 106, by way of the persistent connection, to the web client 104 for processing. When the web client 104 receives the encapsulated structure, it can utilize a library to fire an event including the data or information received in the encapsulated structure to the web service for processing. Once the data or information is processed by the web service, the web client 104 formulates a response that includes an encapsulated structure having a payload. The formulated response is sent to the intermediary server 106. The formulated response can be sent to the intermediary service using a standard connection such as a TCP connection. The intermediary server 106, in turn, processes the response and formulates an HTTP response that is then communicated back to caller 102.

Using this approach, web services supported by web client 104 that reside behind a firewall can be utilized and appear as completely functional HTTP endpoints. Further, by utilizing standard protocols, caller 102 and web client 104 can communicate through NATs or other devices which would otherwise make such communication impossible. Further, because the described approach utilizes standard protocols, no additional plug-ins or special technology is utilized to effect communication, as will be appreciated by the skilled artisan.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, caller 102 and web client 104 may also include an entity (e.g., software) that causes hardware of the caller or web client 104 to perform operations, e.g., processors, functional blocks, and so on. For example, the caller 102 and web client 104 may include a computer-readable medium that may be configured to maintain instructions that cause the associated computing device, and more particularly hardware of the computing device to perform operations. Thus, the instructions function to configure the hardware to perform the operations and in this way result in transformation of the hardware to perform functions. The instructions may be provided by the computer-readable medium to the computing device through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth.

Having considered an example operating environment, consider now a specific example in which the caller and web client reside in the form of computing devices employing web browsers to communicate.

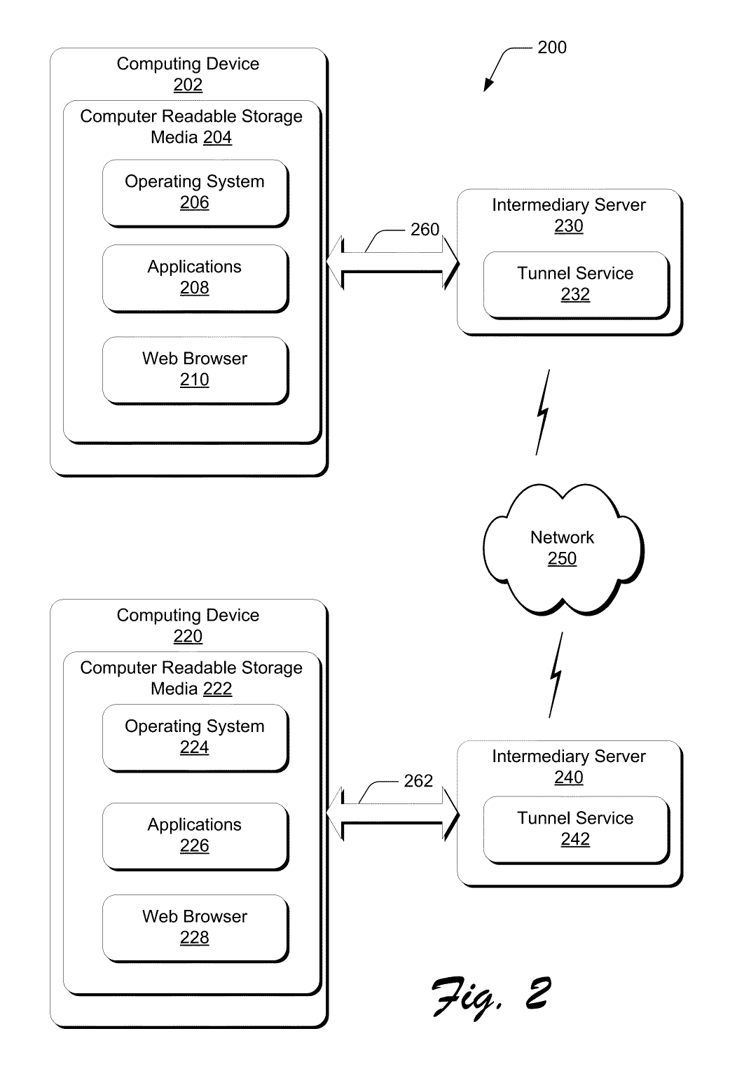

FIG. 2 is an illustration of an environment 200 in an example implementation that is operable to employ techniques described herein. The illustrated environment 200 includes computing devices 202, 220, intermediary servers 230, 240, and a network 250, such as the Internet, communicatively linking intermediary servers 230, 240. The computing devices 202, 220 are configured to implement web services as described below.

Computing device 202 includes computer readable storage media 204 which, in turn, includes an operating system 206, one or more applications 208, and a web browser 210. Computing device 220 includes computer readable storage media 222 which, in turn, includes an operating system 224, one or more applications 226, and a web browser 228. Various resources of the computing devices, e.g., the operating system, operating system resources, applications and/or web browsers, can be represented by a web URL, as will become apparent below. In this manner, web services can be exposed at a variety of levels of granularity, examples of which are provided below.

The operating systems 206, 224 are configured to abstract underlying functionality of their respective computing device to respective applications or web browsers that are executable on the computing device. For example, the operating systems 206, 224 may abstract processing, memory, network, and/or display functionality of their respective computing device such that the applications may be written without knowing “how” this underlying functionality is implemented. The applications, for instance, may provide data to the operating system to be rendered and displayed by a display device associated with the computing device without understanding how this rendering will be performed.

The operating systems may also represent a variety of other functionality, such as that which is utilized to manage a file system and user interface that is navigable by a user of the computing device.

Intermediary server 230 includes, among other components, a tunnel service 232. Likewise, intermediary server 240 includes a tunnel service 242. Any suitable number of computing devices and/or intermediary servers can be utilized. In the illustrated and described embodiment, computing devices 202, 220 represent client computing devices examples of which are provided below.

Computing devices 202, 220 may be configured as a computer that is capable of communicating over the network 250, such as a desktop computer, a mobile station, an entertainment appliance, a set-top box communicatively coupled to a display device, a wireless phone, a game console, and so forth. Thus, the computing devices 202, 220 may range from full resource devices with substantial memory and processor resources (e.g., personal computers, game consoles) to a low-resource device with limited memory and/or processing resources (e.g., traditional set-top boxes, hand-held game consoles).

Although the network 250 is described as the Internet, the network may assume a wide variety of configurations. For example, the network 250 may include or otherwise make use of a wide area network (WAN), a local area network (LAN), a wireless network, a public telephone network, an intranet, and so on. Further, although a single network 250 is shown, the network 250 may be configured to include multiple networks.

In operation, as described below in more detail, various embodiments enable web clients, such as browser based clients like browsers 210, 228 (as well as other non-browser based clients) to provide web services. Browsers 210, 228 are configured to act as servers and can be used for, among other purposes, to and from calling of web services supported by the browser based client. Such uses can include, by way of example and not limitation, pushing messages from one browser to another. The various techniques can be used, for example, to implement browser based chat clients using standard protocols and libraries and without requiring any custom code or plug-in installation in browsers as noted above.

Intermediary servers 230, 240 function as intermediaries and are configured to enable browser based clients to establish persistent connections, here represented at 260, 262 respectively, with a respective intermediary server. The persistent connection, as noted above, can be established using any suitable technologies or techniques. By way of example and not limitation, such technologies or techniques can include COMET, WebSockets, and the like. The intermediary server, in turn, can publish the browser based client to the world using, for example, the browser's presence or address, such as a web service URL. Other web service clients (e.g., another browser based client) seeking to send a message to the first browser based client can use the published web-service URL to call a predefined web-service. The calling browser based client can also register with either the same intermediary server or a different intermediary server and publish its web-service URL. The first browser based client can then use this URL to push messages to the second browser based client.

In operation, the persistent connections 260, 262 are utilized in order to create a tunnel, using respective tunnel services 232, 242, from a web client such as web browser 210, 228 to a respective intermediary server. The persistent connections can be utilized to receive requests from various entities. For example, the persistent connections can be utilized to enable browser based clients, as well as non-browser-based clients, to receive web service requests from other callers, including other browser and non-browser based clients. The intermediary server acts as an externally and continuously available HTTP endpoint. This then allows for emulation of what would happen if the browser could open a socket and start a web server locally for receiving synchronous requests from servers, or processing the responses for asynchronous requests.

As an example, consider the following. Computing device 202 can establish a persistent connection 260 with intermediary server 230. Web browser 210 can register with intermediary server 230 over the persistent connection 260. Likewise, computing device 220 can establish a persistent connection 262 with intermediary server 240. Web browser 228 can likewise register with intermediary server 240 over the persistent connection 262. When web browser 210 wishes to communicate with web browser 228, web browser 210 obtains a web service URL associated with web browser 228. This can be done through, for example, a registry maintained by intermediary server 240. Browser 210 can then use the web service URL to call a web service that is published by web browser 228 to deliver data or other information to web browser 228. Along with the delivered data, web browser 210 can also provide its web service URL to web browser 228. Web browser 228 can then use the web service URL of web browser 210 to deliver data or other information to web browser 210. In one or more embodiments, the web service URLs are addresses associated with intermediary servers 230, 240 respectively. The web service URLs are configured to include identification of an associated browser to enable the intermediary server through its respective tunnel service 232, 242 to ascertain where to deliver data that is the subject of a web service call. Requests made to the tunnel service can be made using a standard TCP connection with the intermediary server. The intermediary server can, in turn, use a persistent connection with an intended recipient to deliver the request to the recipient. Responses from the intended recipient can be sent back to the intermediary service using a standard TCP connection.

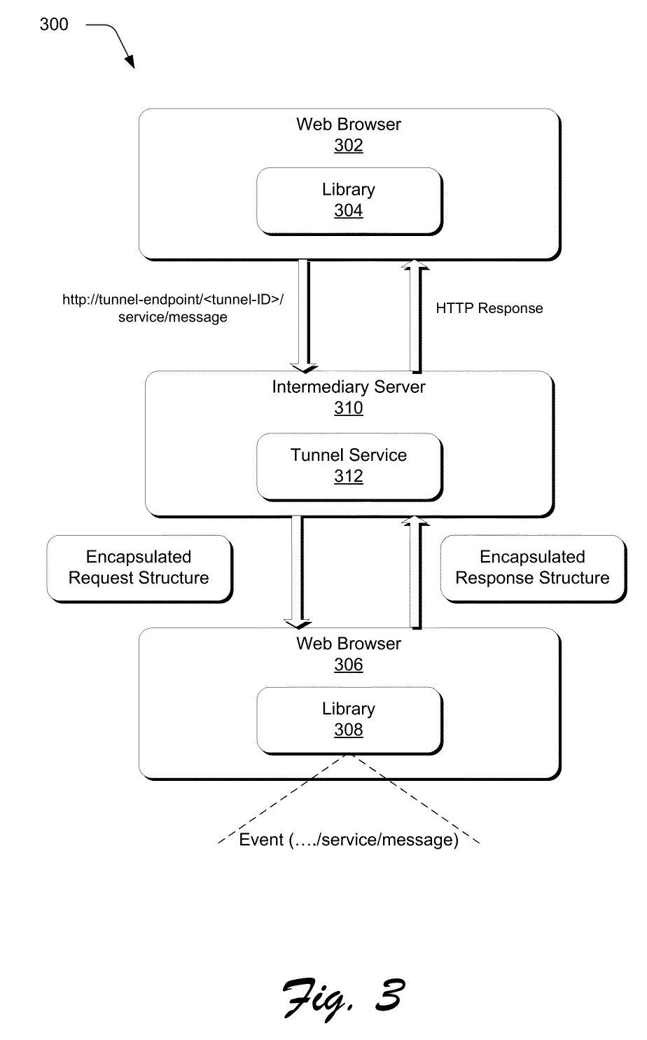

FIG. 3 is an illustration of an example environment 300 in accordance with one or more embodiments. Environment 300 includes a web browser 302 having a library 304, a web browser 306 having a library 308, and an intermediary server 310 that implements a tunnel service 312. In this example, the two web browsers (i.e. web clients) each implement one or more web services and wish to communicate with each other.

In the illustrated and described embodiment, web browsers 302, 306 each include a persistent connection with intermediary server 310 indicated by the arrows. The persistent connection can be utilized to receive web service requests from a caller by way of the intermediary server. Any suitable technology can be utilized to enable the persistent connection to be established. In addition, each of the web browsers is registered with intermediary server 310 using a respective tunnel ID.

In operation, web browser 302 (and web browser 306) utilizes standard web protocols to issue a call in the form of an HTTP request. In this specific example, the HTTP request takes the following form:
http://tunnel-endpoint/<tunnel-ID>/service/message

The call issued by web browser 302 includes the tunnel endpoint (“tunnel-endpoint”) associated with and identifying intermediary server 310, the tunnel ID (“tunnel-ID”) associated with web browser 306 and a payload which identifies a web service implemented by web browser 306 and data or information that is to be processed by the web service implemented by the web browser (“service/message”).

The intermediary server 310 and its tunnel service 312 then process the call by converting it into a standard web structure that can be processed by the web browser. For example, the HTTP request includes a method, a URL, a body and headers. These are utilized to construct a JavaScript structure which is essentially a dictionary having keys and content corresponding to the method, URL, body, and headers. The JavaScript structure is then serialized and encapsulated using JavaScript Object Notation (JSON) to provide an encapsulated request structure. The encapsulated request structure is then communicated by the intermediary server 310 to the web browser 306 for processing utilizing the persistent connection. When the web browser 306 receives the encapsulated request structure, it can utilize library 308 to fire an event including the data or information received in the encapsulated request structure (i.e. “/service/message”) to the web service for processing. Once the data or information is processed by the web service, the web browser 306 formulates a response that includes an encapsulated response structure having a payload, e.g., a response structure encapsulated using JSON. The encapsulated response structure is sent to the intermediary server 310. The encapsulated response structure can be sent to the intermediary server using a standard TCP connection. The intermediary server 310, in turn, processes the encapsulated response structure and formulates an HTTP response that is then communicated back to web browser 302. The HTTP response can be processed in the usual manner by web browser 302.

In addition, the two web browsers 302, 306 may communicate directly with one another by making HTTP requests of one another using the following format:
http://tunnel-endpoint/<respective-tunnel-ID>

Further, in at least some embodiments, if a web service is implemented using Node.JS, which is a server-side JavaScript programming language and execution environment, the same code may be moved from the server to any browser client by simply substituting the tunnel endpoint library for the server instantiation library, as will be appreciated by the skilled artisan. Accordingly, instead of registering to receive incoming Web requests, registration can take place with the client-side JavaScript implementation of the tunneling software which produces identical events as would have been produced had the software been running in the Node.JS environment.

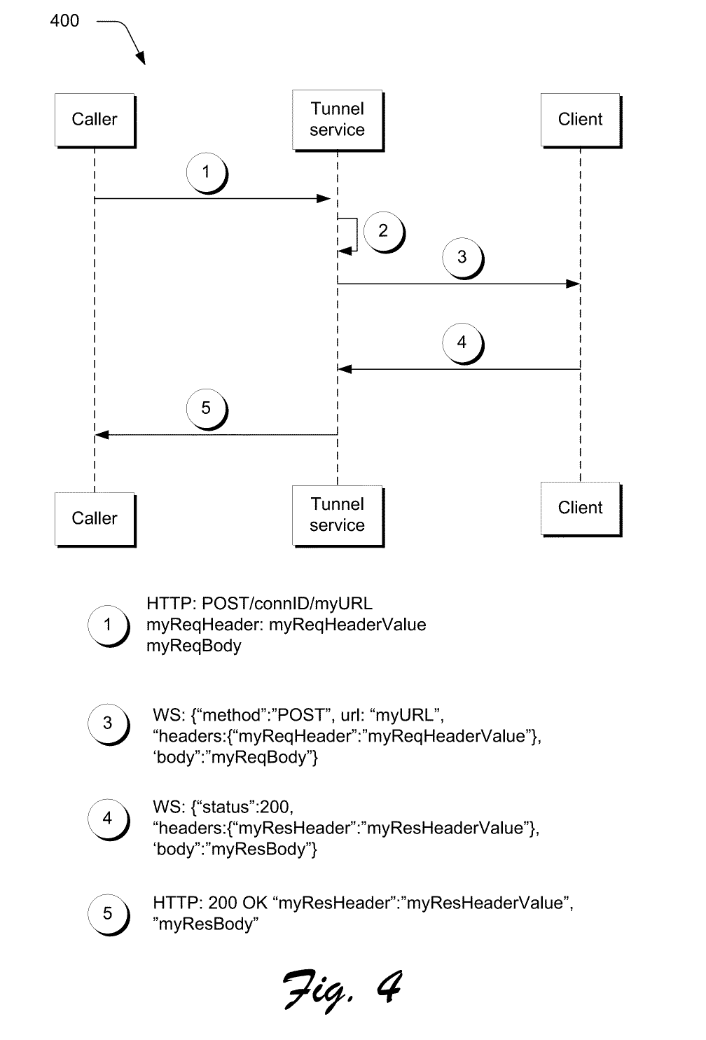

FIG. 4 illustrates an example sequence diagram, generally at 400, which shows how an external HTTP request is encapsulated into JSON and then sent over a persistent connection to a client, e.g., web browser. In this example, authentication is performed but not illustrated. Specifically, authentication may be performed either at the tunnel service by restricting authorized callers to send messages to the clients or at the client (e.g., browser) itself or both.

In the example, a number of actions are illustrated as being performed by entities including a caller, a tunnel service, and a client. Each of the actions is enumerated with an encircled number, which is then qualified below. As noted above, the caller can comprise any suitable entity including, by way of example and not limitation, an end user computing device, a server, a suitably-configured application executing on either the computing device or server, a web browser, and the like. Initially, the caller makes an HTTP request at “1”. Such can, but need not take place over a persistent connection. For example, the HTTP request can be made over a TCP connection that enables communication with the tunnel service. In this example, the HTTP request is a POST and has the form shown just below the illustration. The “connID” corresponds to the tunnel-ID with which the client is registered. The “myURL” corresponds to the “service/message” which is part of the payload.

The tunnel service receives the HTTP request and, at “2” selects a connection that matches “connID”. The tunnel service serializes the HTTP request and encapsulates it in JSON at “3”. The serialized encapsulated request structure is shown just below the illustration. The client receives the encapsulated request structure over a persistent connection and, using a suitably-configured library, processes the encapsulated request structure and fires an appropriate event containing information and data to enable the client-supported web service to process the information and data. The client then prepares an encapsulated response structure that is encapsulated in JSON and returns the encapsulated response structure at “4” to the tunnel service. The structure of the encapsulated response structure is shown just below the illustration. This response can be sent to the tunnel service using a standard TCP connection.

The tunnel service then processes the encapsulated response structure and prepares an HTTP response that is sent at “5” to the caller. The structure of the HTTP response is shown just below the illustration. The response includes an HTTP status code 200 indicating that the request was fulfilled, along with a payload that includes information and data resulting from the web service's processing of the caller's request. The response can now be processed by the caller as a typical HTTP response.

In addition to the above discussion, additional considerations can be taken into account. As an example, consider the following.

Other Considerations

With respect to security considerations, consider the following. In one or more embodiments, to facilitate confidentiality, communication between callers and the intermediary server, and the intermediary server and client, can take place over a secure transport, such as, by way of example and not limitation, utilizing Transport Layer Security (TLS) or Secure Sockets Layer (SSL). In the case of HTTP communication, HTTPS can be utilized. Further, to ensure that service requests are limited to authorized systems, a service account can be utilized. Service accounts can utilize account keys. In this manner, the caller of a service can sign its HTTP request with this key, thus facilitating the proof that it indeed possesses the key and associated account. This signature can be implemented using any suitable cryptographic method, e.g. HMAC (Hash-based Message Authentication Code). Such signature can be attached to the HTTP request in an additional authorization header. This signature can be checked by the service upon receipt of the request, and if the check is successful, the service request can be filled.

Further, if the caller of the service is a client rather than a server, an additional provision can be utilized in order to ensure security of the account key. On the client, typically the key cannot be assumed as safely stored, as it can be when stored on the server. To this end, temporary account keys can be utilized coupled with a procedure for obtaining these in exchange for other security credentials. Such key would have limited validity, for example, by expiring after one day, or within a pre-defined time period. Further, a client that connects to the service can also be asked to authorize itself, using the same technique of temporary keys as mentioned above.

In addition, from a security standpoint, a mechanism can be utilized by a tunnel service to ensure that authorized systems can have their web service requests relayed to any given client. This is accomplished using cryptographically random connection IDs that are assigned to the client connection, and are embedded in the client's individual service URL. The client gives that URL only to the systems it wants to send requests to. Any other system will not be able to make requests by the simple fact that it does not know, or cannot guess, the service URL/connection ID assigned to the client.

From an extensibility standpoint, consider the following. As noted above, callers can comprise any suitable type of entity. For example, in the discussion above, a web browser was used to initiate calls to a particular web service or other web browser. Consider the situation in which an operating system itself can maintain a persistent connection with a suitably-configured intermediary server. In this instance, the operating system can expose its individual resources as URLs that can be accessed using the techniques described above. For example, individual tiles that might appear on a display screen can be associated with individual URLs. Content associated with the individual tiles can be updated by a service using a push model. For example, rather than having the operating system fetch or otherwise acquire updates proactively, updates can be pushed to operating system resources at their associated URLs. So, for example, if a tile is to be updated, a web service can use the tile's associated URL and make an HTTP POST request that gets tunneled to the particular tile. For example, the computing system may have a tile associated with weather updates. Rather than having to go retrieve the weather updates, such updates can be pushed to the tile using the techniques described above.

As another example, consider calling services. Utilizing calling services, clients can call one another using, for example, Voice over Internet Protocol (VoIP). In these scenarios, if a client has an incoming call, rather than utilizing specialized call servers, the techniques described above can be utilized in connection with HTTP-based call servers to be able to send an HTTP request associated with an incoming call directly to a client, resulting in a push call notification.

With respect to web browser scenarios, consider the following. RTC-Web (Real-Time Collaboration on the World Wide Web) is an effort to achieve a standardized infrastructure in web browsers on which real-time interactive communication between users of the web can be achieved. Using RTC-Web, peer-to-peer audio and video media sessions can be established between web browsers. Using data channels established between browsers through RTC-Web, web services that are supported by the web browsers can utilize the techniques described above to bypass the intermediary server to communicate with one another. In this manner, library functions that are implemented by the web browsers can make HTTP calls to one another to access and utilize web services supported by the web browsers.

Further, the above-described techniques greatly facilitate scalability. For example, as clients or callers grow, intermediary servers exposing a tunnel service can be easily added to accommodate such growth. Using this type of scalability, processing overhead associated with load balancers can be greatly reduced. Specifically, typically load balancers are used in large systems to ascertain where to direct calls. Once a load balancer determines a connection to an intermediary server responsive to a call, load-balancing need not be utilized for that caller in the future. That is, once the connection is ascertained, subsequent calls can be made directly to the intermediary server without necessarily utilizing the load balancer.

With respect to scalability, consider the following. Scalability can be supported and built into the way that tunnel URLs are built. For example, a tunnel URL can have the form shown just below:
http://trouterX.trouter.net/connectionID

where trouterX.trouter.net is a domain name of a specific instance of the server hosting the persistent connection. This allows all servers to operate independently without the need for finding one another and delegating the web service requests to one another. The job of finding the right server is left to the Internet, e.g., the DNS. In this embodiment, the system has no shared state between the server instances. This is a prescription for unbounded scalability, as will be appreciated by the skilled artisan.

This is in contrast, for example, with an alternative approach where the URL may take the form:
http://alternativeservice.net/app-assigned-ID

In this approach, the request is routed initially to a random server that typically does not have the connection. Hence, this random server must find the connection owner and delegate to it. The situation is exacerbated by the tunnel/connection ID selected by the application, thus preventing the service from embedding the routing information into the URL. This leads to a need for a persistent store to keep the routing information, keyed by the “app-assigned-ID”, as will be appreciated by the skilled artisan.

Having considered an example sequence diagram and other considerations in accordance with one or more embodiments, consider now a discussion of an example procedure that can be implemented in accordance with one or more embodiments.

Example Procedures

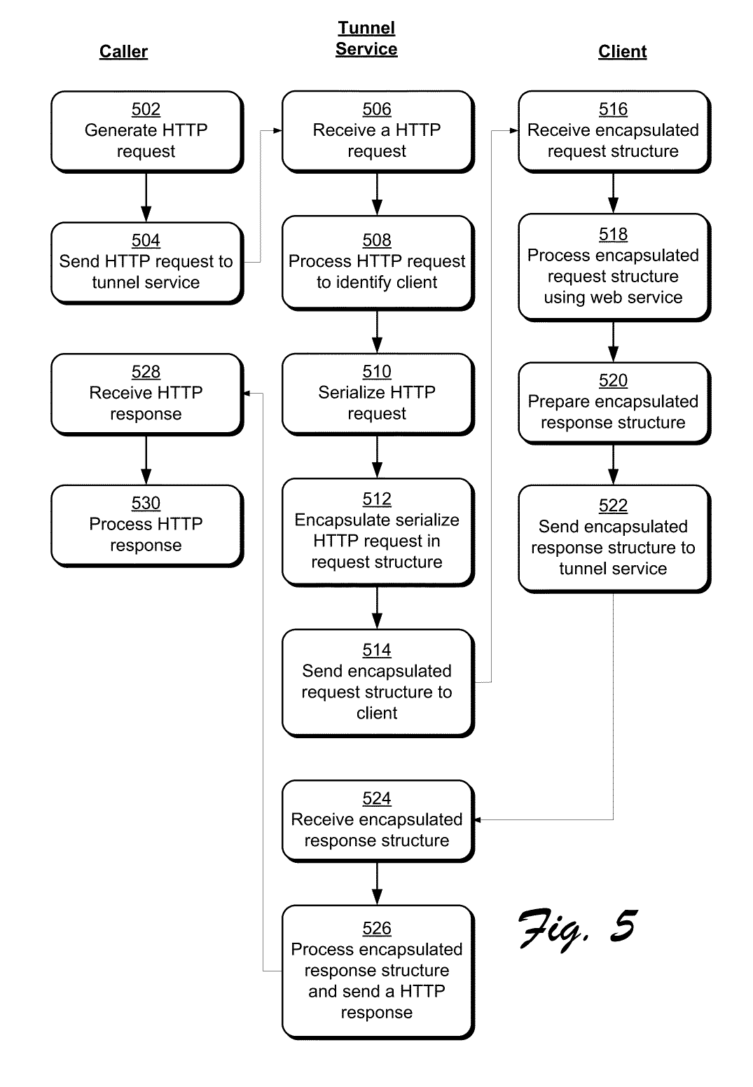

FIG. 5 describes a communication flow that takes place between a caller, a tunnel service, and a client in a manner that enables the client to provide a web service. The communication flow may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks.

At block 502, a caller generates an HTTP request associated with a web service provided by a suitably configured web client. Examples of HTTP requests are provided above. Block 504 sends the HTTP request to a tunnel service. This request can be sent over a standard TCP connection.

Block 506 receives the HTTP request and block 508 processes the HTTP request to identify the client. This can be performed in any suitable way, examples of which are provided above. Block 510 serializes the HTTP request and block 512 encapsulates the serialized HTTP request in a request structure. This can be performed in any suitable way. In at least some embodiments, the serialized HTTP request is encapsulated in JSON as described above. Block 514 sends the encapsulated request structure to the client. In one or more embodiments, the encapsulated request structure is sent over a persistent connection maintained between the tunnel service and the client.

Block 516 receives, at the client, the encapsulated request structure. Block 518 processes the encapsulated request structure using, at least in part, a web service. Block 520 prepares an encapsulated response structure that includes at least data and information associated with execution of the web service. Block 522 sends the encapsulated response structure to the tunnel service. In one or more embodiments, the encapsulated response structure can be sent over a standard TCP connection.

Block 524 receives, at the tunnel service, the encapsulated response structure. Block 526 processes the encapsulated response structure and sends an HTTP response to the caller. Examples of how this can be done are provided above.

Block 528 receives, at the caller, the HTTP response and block 530 processes the HTTP response. This can include processing the data and information that is included in the HTTP response as a result of the client executing the Web service.

Having described example procedures in accordance with one or more embodiments, consider now an example system and device that can be utilized to implement the embodiments described above.

Example System and Device

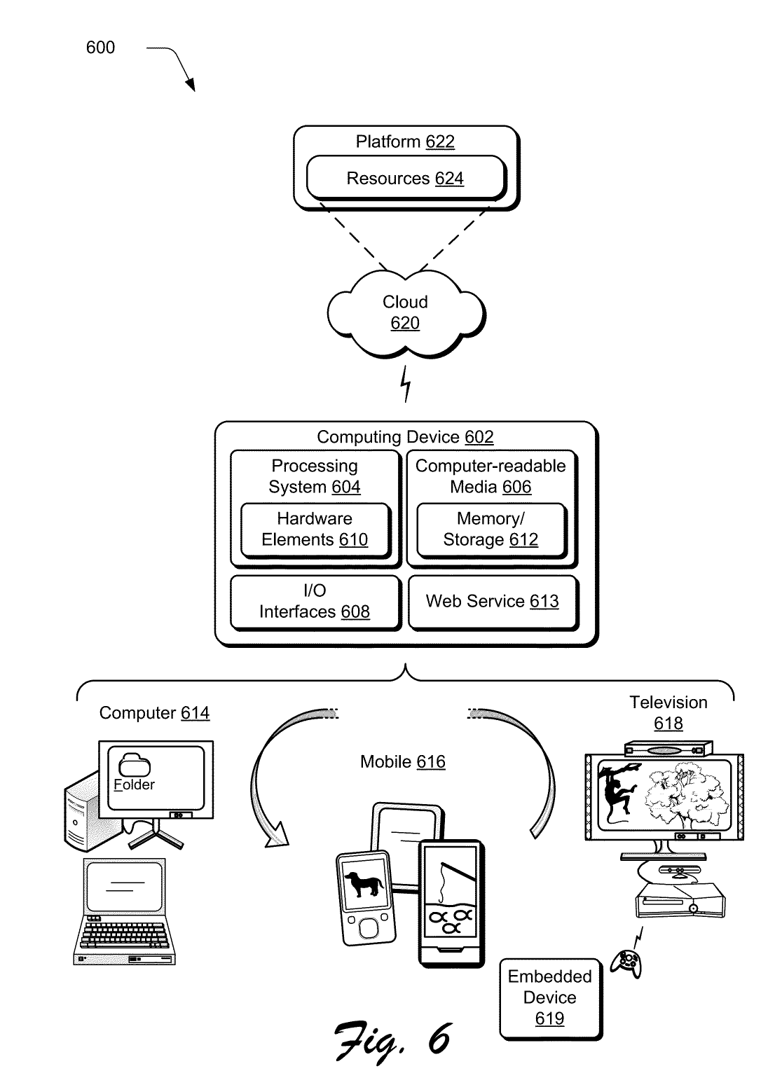

FIG. 6 illustrates an example system generally at 600 that includes an example computing device 602 that is representative of one or more computing systems and/or devices that may implement the various techniques described herein. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interface 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware elements 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 606 is illustrated as including memory/storage 612. The memory/storage 612 represents memory/storage capacity associated with one or more computer-readable media. The memory/storage component 612 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways as further described below to support user interaction.

Computing device 602 also includes one or more web services 613 that it can offer and which can be utilized by various callers using the techniques described above.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

As further illustrated in FIG. 6, the example system 600 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 600, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 602 may assume a variety of different configurations, such as for computer 614, mobile 616, television 618, and embedded device 619 uses. Each of these configurations includes devices that may have generally different constructs and capabilities, and thus the computing device 602 may be configured according to one or more of the different device classes. For instance, the computing device 602 may be implemented as the computer 614 class of a device that includes a personal computer, desktop computer, a multi-screen computer, laptop computer, netbook, and so on.

The computing device 602 may also be implemented as the mobile 616 class of device that includes mobile devices, such as a mobile phone, portable music player, portable gaming device, a tablet computer, a multi-screen computer, and so on. The computing device 602 may also be implemented as the television 618 class of device that includes devices having or connected to generally larger screens in casual viewing environments. These devices include televisions, set-top boxes, gaming consoles, and so on.

The computing device 602 may also be implemented as an embedded system or embedded class of device 619. Embedded devices are typically designed for specific control functions. As such, embedded devices can be typically dedicated to handling a particular task. Embedded devices can be widely ranging from such things as digital watches, media players, light switches, traffic lights, factory controllers, telephone switches, various other types of consumer electronics, GPS receivers, printers, household appliances such as microwave ovens, washing machines, dishwashers, HVAC systems including networked thermostats, home automation devices that use wired or wireless networking to control such things as lights, climate, security, audio/visual, surveillance, and the like. Other embedded devices can be used in transportation systems, various types of motors, medical equipment for such things as vital sign monitoring, medical imaging, and the like.

The techniques described herein may be supported by these various configurations of the computing device 602 and are not limited to the specific examples of the techniques described herein. This functionality may also be implemented all or in part through use of a distributed system, such as over a “cloud” 620 via a platform 622 as described below.

The cloud 620 includes and/or is representative of a platform 622 for resources 624. The platform 622 abstracts underlying functionality of hardware (e.g., servers) and software resources of the cloud 620. The resources 624 may include applications and/or data that can be utilized while computer processing is executed on servers that are remote from the computing device 602. Resources 624 can also include services, such as web services, provided over the Internet and/or through a subscriber network, such as a cellular or Wi-Fi network.

The platform 622 may abstract resources and functions to connect the computing device 602 with other computing devices. The platform 622 may also serve to abstract scaling of resources to provide a corresponding level of scale to encountered demand for the resources 624 that are implemented via the platform 622. Accordingly, in an interconnected device embodiment, implementation of functionality described herein may be distributed throughout the system 600. For example, the functionality may be implemented in part on the computing device 602 as well as via the platform 622 that abstracts the functionality of the cloud 620.

### CONCLUSION

Various embodiments enable web clients to provide web services. In one or more embodiments, web clients are configured to act as servers and can be used for, among other purposes, to and from calling of web services supported by the web client. Such uses can include, by way of example and not limitation, pushing messages to and from the web client. The various techniques can utilize standard protocols and libraries and without the need for any custom code or custom plug-ins.

In one or more embodiments, an intermediate server functions as an intermediary with which a persistent connection with a web client is established. The intermediary server, in turn, can publish the web client to the world using, for example, the web client's presence or address, such as a web service URL. Other web clients (e.g., a browser based client) seeking to send a message to the first web client can use the published web-service URL to call a predefined web-service. The calling web client can also register with either the same intermediary server or a different intermediary server and publish its web-service URL. The first web client can then use this URL to push messages to the second web client.

Although the various embodiments have been described in language specific to structural features and/or methodological acts, it is to be understood that the embodiments defined in the appended claims are not necessarily limited to the specific features or acts described. Rather, the specific features and acts are disclosed as example forms of implementing the various claimed embodiments.

What is claimed is:

1. A method comprising:
generating an HTTP request associated with a web service provided by a web client;
sending the HTTP request to an intermediary server implementing a tunnel service;
receiving, from the tunnel service, an HTTP response associated with the HTTP request; and
processing the HTTP response, the HTTP response including data and information associated with an execution result of the web service by the web client.

2. The method of claim 1, wherein the HTTP request includes a tunnel endpoint associated with the intermediary server, a tunnel ID associated with the web client, and a payload which identifies the web service and includes data or information that is to be processed by the web service.

3. The method of claim 1, wherein said generating, sending, receiving, and processing are performed by a caller comprising a client computing device.

4. The method of claim 1, wherein said generating, sending, receiving, and processing are performed by a caller comprising a browser.

5. The method of claim 1, wherein said generating, sending, receiving, and processing are performed by a caller comprising a browser and said web client comprises another browser.

6. The method of claim 1, wherein said generating, sending, receiving, and processing are performed to implement browser-based chat between two web browsers.

7. One or more computer readable storage media embodying computer readable instructions which, when executed, implement a method comprising:
receiving, at a tunnel service, an HTTP request from a caller, the HTTP request intended for a web client that supports a web service;
serializing the HTTP request;
encapsulating the serialized HTTP request in a request structure;
sending the encapsulated request structure to the web client;
receiving, at the tunnel service, an encapsulated response structure from the web client, the encapsulated response structure including data or information associated with execution of the web service; and
processing the encapsulated response structure to provide an HTTP response and sending the HTTP response to the caller, the HTTP response including the data or information.

8. The one or more computer readable storage media of claim 7, wherein said encapsulating is performed by encapsulating the serialized HTTP request in JavaScript Object Notation.

9. The one or more computer readable storage media of claim 7, wherein the caller comprises a browser.

10. The one or more computer readable storage media of claim 7, wherein the web client comprises a browser.

11. The one or more computer readable storage media of claim 7, wherein the caller comprises a browser and the web client comprises another browser.

12. The one or more computer readable storage media of claim 7, wherein said receiving is performed by receiving the HTTP request over a TCP connection with the caller.

13. The one or more computer readable storage media of claim 7, wherein said sending the encapsulated request structure is performed by sending the encapsulated request structure over a persistent connection to the web client.

14. The one or more computer readable storage media of claim 7, wherein said receiving is performed by receiving the HTTP request over a TCP connection with the caller and said sending the encapsulated request structure is performed by sending the encapsulated request structure over a persistent connection to the web client.

15. One or more computer readable storage media embodying computer readable instructions which, when executed, implement a method comprising:
receiving, at a web client that is not a server, an encapsulated request structure from a tunnel service, the encapsulated request structure being associated with a web service provided by the web client;
processing the encapsulated request structure using, at least in part, the web service;
preparing an encapsulated response structure that includes at least data and information associated with execution of the web service; and
sending the encapsulated response structure to the tunnel service.

16. The one or more computer readable storage media of claim 15, wherein the encapsulated response structure is encapsulated using JavaScript Object Notation.

17. The one or more computer readable storage media of claim 15, wherein said receiving comprises receiving the encapsulated request structure over a persistent connection with the tunnel service.

18. The one or more computer readable storage media of claim 15, wherein the web client comprises a browser.

19. The one or more computer readable storage media of claim 15, wherein the web client comprises a browser, and wherein said processing the encapsulated request structure comprises firing an event that includes data or information contained in the encapsulated request structure.

20. The one or more computer readable storage media of claim 15, wherein the encapsulated request structure is associated with a first web browser that called the tunnel service, and the web client comprises another web browser.
